(19) United States
(12) Patent Application Publication
(10) Pub. No.: US 2013/0037343 A1
(43) Pub. Date: Feb. 14, 2013

(54) ADJUSTABLE STAND SUITABLE FOR SUPPORTING AN AUDIO SPEAKER

(71) Applicant: Brent Smith, County Dublin (IE)

(72) Inventor: Brent Smith, County Dublin (IE)

(21) Appl. No.: 13/518,616

(22) PCT Filed: Dec. 16, 2010
(86) PCT No.: PCT/IB10/55853

§ 371 Date: Jun. 22, 2012

Related U.S. Application Data
(60) Provisional application No. 61/289,097, filed on Dec. 22, 2009.

(30) Foreign Application Priority Data
Dec. 22, 2009 (GB) 0922408.0

(51) Int. Cl. G10K 11/00

(52) U.S. Cl. 181/175

(57) ABSTRACT

The invention relates to an adjustable stand suitable for supporting an audio speaker and comprising: a base having an upright bearing; a tilt barrel mounted on the upright bearing for adjustable rotation about its own axis; two supporting rods, each supporting rod being mounted on the tilt barrel generally perpendicular to the tilt barrel axis and adapted for movement sideways along the tilt barrel and forwards and backwards relative to the tilt barrel; and a front and rear rest disposed on each supporting rod, at least one of which is mounted for movement along the rod; and an alternative tilt platform that is less complex than a tilt barrel and supporting rods, but which permits the invention to achieve rotation and tilt for a lower-cost commercial embodiment.

### TECHNICAL FIELD OF THE INVENTION

The present invention relates in general to audio speaker stands and in particular to audio speaker stands that have an isolating base, the capability to bear heavy speakers, and to rotate and tilt the speaker for the optimum hearing location with respect to the listener.

### BACKGROUND TO THE INVENTION

There remains a need for a dynamic means of resting an audio speaker on a base, enabling it to be rotated and tilted for an optimum audio location and experience in relation to the listener. There are a number of static, acoustic foam bases and a few static wooden and metallic or alloy bases available, but none that can satisfactorily resolve a number of issues that arise when designing a dynamic and adjustable base to support heavy, vibrating speakers rested atop, with sufficient flexibility in design to encompass the extreme variability encountered in the considerable range of audio speakers manufactured.

This need applies whether the speaker is to be situated on a desktop, in a bookcase, on the floor, or on the meter bridge atop a recording console or other support location in a recording studio, and at whatever distance from the listener the speaker is situated (such as reclining on a lounge, or at a desktop). These may be termed normal uses of the invention.

Static bases do not resolve an optimum audio experience because they cannot dynamically adjust the rotation and tilt of an audio speaker, whilst at the same time provide full load-bearing support for heavy, vibrating speakers, anti-vibration separation between the base and the floor or desktop, and a robust methodology for ‘fixing’ each adjustment sufficient to ensure extreme audio vibration will not work loose the fixed state.

In addition, the performance of a speaker cannot be considered separately from the surface upon which the speaker is mounted, a phenomenon known as coupling, whereby audio colouration occurs and is variable, according to the mounting surface. There is a clear need to provide mechanical vibration isolation and a standardised mounting platform, as well as optimum aural field location via rotation and tilt mechanisms, when assessing the field performance of different speakers.

Modern audio speakers come in two modes—passive and active. Since active speakers generally locate power, bi-amplification and frequency cross-over circuitry within the speaker enclosure itself, they are heavier than passive speakers. For this reason, requirements for passive speakers can generally be encompassed by reference only to active speakers in this design.

Active speakers present real design issues for a dynamic support device, since they often have heat vanes protruding from the rear, and a plethora of connectors, circuitry, adjustment knobs, power outlets and bass ports, around which to place rear supports, particularly when tilting the speaker backwards to achieve the optimum angle for listening.

Speakers also come generally in three approximate size families—small, medium and large, against which we can compute reasonable averages for dimensions and weight, and allow a little extra for margin. When assessing the design issues associated with commercially and readily available speakers, one can see a number of rear backplane details that may impede a useful design. Some speakers have rear bass ports, or volume pots, power and audio adjustment switches, protruding heat vanes, angled inclines and so forth.

Ideally, when designing a speaker platform, the smallest surface area of ‘touch’ between the platform and the speaker is considered optimal. The surface area that touches the speaker should be of a vibration and sound wave absorbing material, such as SBR Shore A synthetic rubber, or sustainable natural rubber, for example. Many speaker manufacturers are now offering small, static point-source legs that minimise the area of contact between the speaker and the mounting surface. Speaker examples with point-source legs include the Yamaha SOAVO 1, the Focal CM65, The Klipsch F-10, M-Audio AV40, and others.

There are none, however, that resolve vibration isolation and optimum aural location through rotation and tilt, whilst being robust enough to withstand high levels of audio and its associated mechanical vibration.

In addition to the external features mentioned above, the Centre of Gravity (CoG) of a speaker has two characteristics relevant to this design: firstly, the CoG varies greatly between speakers, since the weight of the magnets employed and other circuitry, are correlated with internal design, audio quality, price, and with speaker size and type; and secondly, to tilt and rotate a speaker, the CoG shifts in relation to the tilt mechanism and base and this factor has to be taken into account in terms of base construction to avoid tipping over, vibration isolation, robustness, and fit for purpose.

Finally, it is necessary to take into account floor, desktop, bookshelf and fixed-base placement of the invention, and the possibility that some more specialised uses may require speakers to be placed on a dynamic support device and adjusted with a more radical tilt requirement, such as for close-field foldback monitoring where the speaker and platform are located on the floor for a vocalist—i.e. with a more radical tilt than normal use. This may be termed a more specialised use of the invention

It is an object of the invention to overcome at least one of the above-referenced problems.

### BRIEF SUMMARY OF THE INVENTION

Disclosed according to the invention there is provided an adjustable support stand suitable for supporting an audio speaker and comprising:

a sound isolating base made from acoustic dampening materials, typically SBR synthetic rubber; and
an alloy base plate atop the sound isolating base, having a front, a rear, sides and an upright bearing atop a horizontally rotatable support; and
a speaker rest base plate mounted on the bearing, or two horizontal supporting rods, mounted on the bearing by means of a vertically tiltable support; and
a horizontal rest plate, or a front and rear horizontal rest disposed on each horizontal supporting rod, at least one of which is mounted for movement along the rod, wherein each supporting rod is preferably movable relative to the tiltable support in a sideways, forwards and backwards direction; and
at least two vertical back-rods with at least one vertical rest on each, orthogonal to the horizontal rests; and
means of locking the tilt and rotate functions; and
a means of managing power and audio cables and laying them in an orthogonal manner to each other to minimise electrical interference.

Where supporting rods are used, each supporting rod is preferably movable relative to the tiltable support in a sideways, forwards and backwards direction.

In one embodiment of the invention, the tiltable support comprises a tilt barrel which extends generally across the base, suitably over a center portion of the base, and is capable of rotation about its own axis.

In other embodiments, the tiltable support is a tiltable baseplate upon which the speaker rests, without a tilt barrel but capable of movement forwards and backwards, atop a central bearing that has a horizontally rotatable support.

### BRIEF DESCRIPTION OF THE FIGURES

We use Figures to illustrate embodiments of the invention. All Figures are given by way of examples of certain embodiments only. Although the present invention has been described with reference to preferred embodiments, workers skilled in the art will recognize changes may be made in form and detail without departing from the spirit and scope of the invention.

FIGS. 1 to 15 describe a generic embodiment of the invention—referred to as the ‘1^{st} embodiment’.

FIG. 1 is the side elevation of a generic embodiment of the invention.

FIG. 2 is the front elevation of a generic embodiment of the invention.

FIGS. 3 to 15 refer to features of the 1^{st} embodiment’.

FIG. 16 is a 3D elevation of a potential commercial embodiment of the invention encompassing complex manufacture and professional features—referred to as the ‘2^{nd} embodiment’.

FIGS. 17 to 34 refer to features of the 2^{nd} embodiment.

FIG. 35 is a 3D elevation of a potential commercial embodiment of the invention encompassing less complex design and manufacture intended for a lower-cost model—referred to as the ‘3^{rd} embodiment’.

FIG. 36 is a 3D elevation of an alternative potential commercial embodiment of the invention encompassing less complex design and manufacture intended for a lower-cost model—referred to as the ‘4^{th} embodiment’.

### DETAILED DESCRIPTION OF THE INVENTION

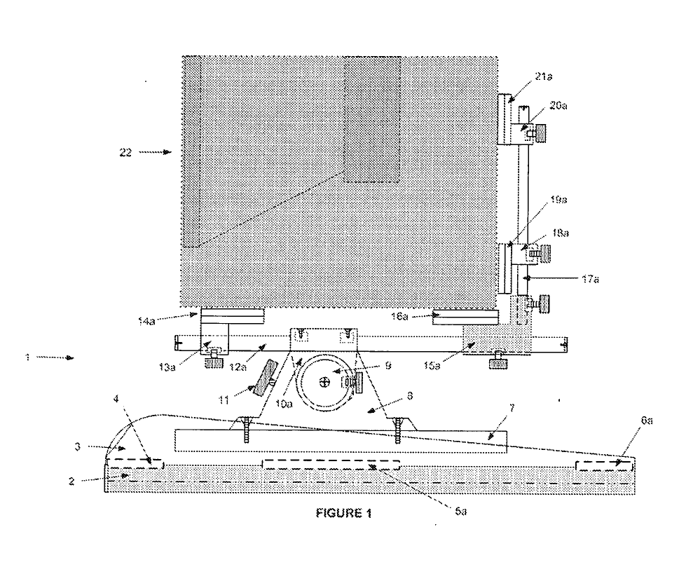

Referring FIG. 1, there is illustrated an adjustable stand according to the invention suitable for supporting an audio speaker and indicated generally by the reference numeral 1.

The stand 1 comprises an isolating base 2 made typically from SBR rubber or similar materials with the properties of isolating mechanical vibration. The isolating base 2 may be gusseted and with a layer filled with sand—as described further below.

Atop the isolating base is an elongated alloy base plate 3 having five SBR rubber or similar material feet, namely a square front foot 4 located adjacent a front of the base, two rectangular side feet 5a located on each side of the base, and two square rear feet 6a located at each side of the rear of the base.

Fitted to the base plate 3 are i) a rotating horizontal assembly 7 supporting an upright central bearing assembly 8 and supporting a tilt barrel 9 rotatably mounted on the bearing assembly for tilting rotation about its own longitudinal axis, and ii) speaker rest assemblies identified and explained further below.

The tilt operation of the central tilt barrel is achieved via a worm drive (not shown here but explained in further detail below), internal to the central bearing assembly. The tilt mechanism operating on the internal worm drive is achieved by operation of a front central tilt wheel 11.

Fitted to the tilt barrel 9 are two supporting horizontal under-rods (‘supporting under-rods’) 12a, adjustably mounted to the tilt barrel by means of clamps 10a, described in more detail below.

Fitted to each supporting under-rod are adjustable front speaker rest clamps 13a, together with their SBR rubber or similar speaker rests 14a, adjustable for movement along each rod. Each front horizontal clamp and rest is referred to collectively as a ‘front horizontal rest unit’

At the rear of each under-rod, is fitted a rear L-shaped rod assembly 15a, that has mounted to it each horizontal rear rest 16a, with a bore to accept the supporting under-rod, and additionally, a vertical bore to accept each vertical back-rod (‘back-rod’) 17a. Each rear horizontal rest is mounted on the rear rod assembly and is referred to as a ‘rear horizontal rest’ The vertical rear speaker rest clamps (‘vertical clamps’) 18a, 20a, are each mounted on the back-rods, having vertical rear speaker rests (‘vertical rests’) 19a, 21a, affixed, and are made from isolating materials such as SBR rubber or similar Each vertical clamp and rest is referred to collectively as a ‘vertical rest unit’

A resemblance of a speaker fitted atop the stand 22 is provided for illustration purposes.

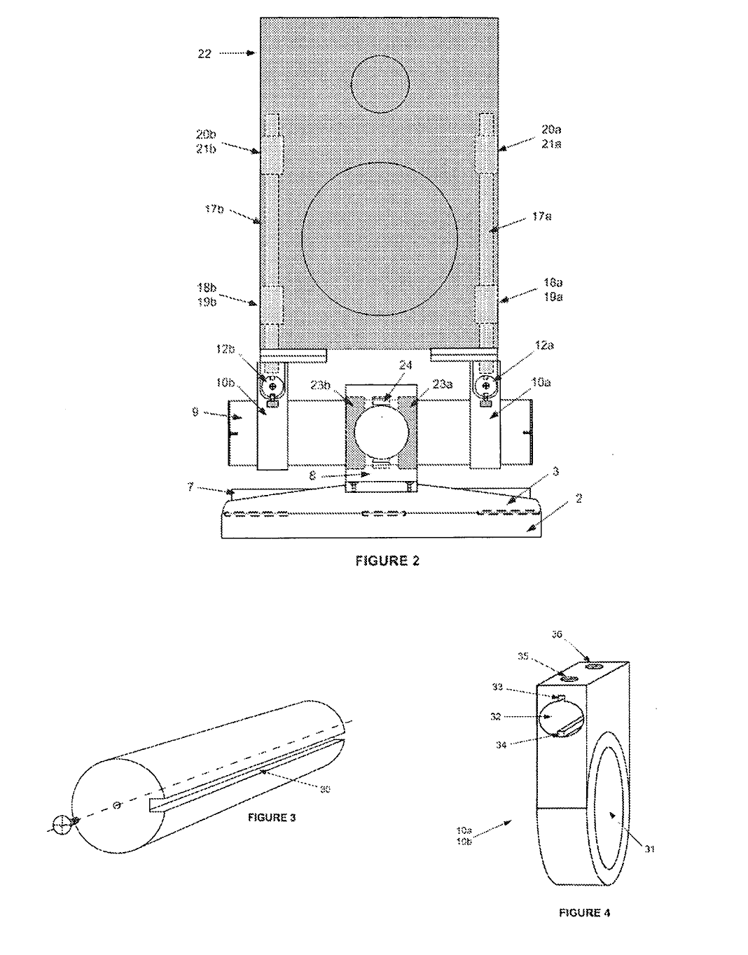

Referring to FIG. 2, and to provide further clarity to FIG. 1, it illustrates a front elevation of the same generic stand. The apparent features to note in relation to FIG. 1 are the isolating base 2, the alloy baseplate 3, the horizontal rotating ring 7, the tilt barrel 9, the speaker rest assembly clamps 10a 10b, the horizontal supporting rods 12a, 12b, and the vertical speaker rods, and vertical rest units 17a 17b 18a 18b 19a 19b 20a 20b 21a 21b.

Shown on FIG. 2 but not on FIG. 1 are the central bearing assembly load-bearings 23a 23b, and the central cog with circumferential teeth 24 adapted to engage the rotation mechanism for tilting the barrel.

Referring to FIGS. 1 and 2, the upright central bearing assembly 8 comprises a circular base 7 dimensioned to fit snugly into the depressed socket of the base plate 3, and allow relative rotation between the bearing and the base. The base of the bearing and the socket are adapted to allow limited rotation not exceeding 55 degrees of each side of the centered position. In the centered position, the tilt barrel 9 lies generally perpendicular to a longitudinal axis of the stand 1. An upper part of the upright bearing 8 includes a bore (not shown) adapted to receive the tilt barrel 9, and includes a tilting nut 11 for accurate tilting (rotation) of the tilt barrel in a smooth and controlled manner.

The rotation mechanism is a worm drive with suitable gearing cogs and a ratchet locking mechanism for precisely locating and fixing an increment of tilt. In various embodiments, the unit components and ratios are sized differently in accordance with the speaker families average dimension and weight rations, which also will result in variable increments of tilt and precise operation according to size and purpose, but the underlying invention and operation remain generic.

Referring to FIG. 3, the tilt barrel 9 has a longitudinal groove 30 which acts as a guide to maintain the perpendicular relationship between the tilt barrel and the supporting rod clamps as explained in more detail below.

Explaining the rod clamps and referring to FIG. 4, with references from FIGS. 1-3, each of the horizontal supporting rods 12a, 12b is mounted on the tilt barrel 9 by means of a connecting clamp 10a, 10b, comprising a first bore 31 adapted for embracing the tilt barrel 9 and a second bore 32 adapted for embracing a supporting rod 12. The second bore 32 includes a longtitudinal groove 33 and a longtitudinal detent 34, both adapted to mate with corresponding formations on the supporting rods. The upper part of each clamp 10a, 10b, includes a pair of locking screws 35, 36 adapted to lock the clamp in position of the supporting rod 12.

The purpose of the mating relationship between the second bore 32 and the rod 12 is to prevent any rotation movement but to also allow the rod to be adjusted forwards and backwards in the bore to a new fixed position by the unscrewing of the locking screws and re-locking, once the rods have been moved. This is to permit the invention to be operated for a specialist use, namely as a floor monitor stand for a vocalist that requires a more extreme tilt than the more normal uses as defined previously. This will be explained and shown further below.

Referring to FIG. 5, each clamp 10a, 10b also includes a locking nut 37 having a cuboid end 38 (a ‘key’), dimensioned to engage the longitudinal groove in the tilt barrel 9 to prevent relative rotation there between and also to lock the clamp in position on the tilt barrel.

Thus, the two supporting rods (refer FIG. 2 references 12a, 12b are fixed to the tilt barrel 9 by means of connecting clamps 10a, 10b, enabling the supporting rods to tilt with the tilt barrel 9, and allowing forwards and backwards movement of the supporting rods relative to the tilt barrel by loosening of the locking screws 35, 36, and allowing sideways movement of supporting rods by loosening of the locking nut 37 on the connecting clamp.

Explaining the operation of the horizontal and vertical speaker rests, and referring to FIGS. 6, 7, and 8, each horizontal supporting rod 12 has clamped to it two rests suited for supporting a speaker, namely a front rest 14 and a rear rest 16. FIG. 6 shows a front elevation of a left side horizontal rest assembly comprising a clamp 13 having a bore adapted for receiving a supporting rod 12, a locking nut 40 adapted to engage the groove on the supporting rod 12, and an overhanging upper platform 14 for supporting the speaker. The right side front horizontal rest assembly (not shown) would simply be a mirror-image of FIG. 6.

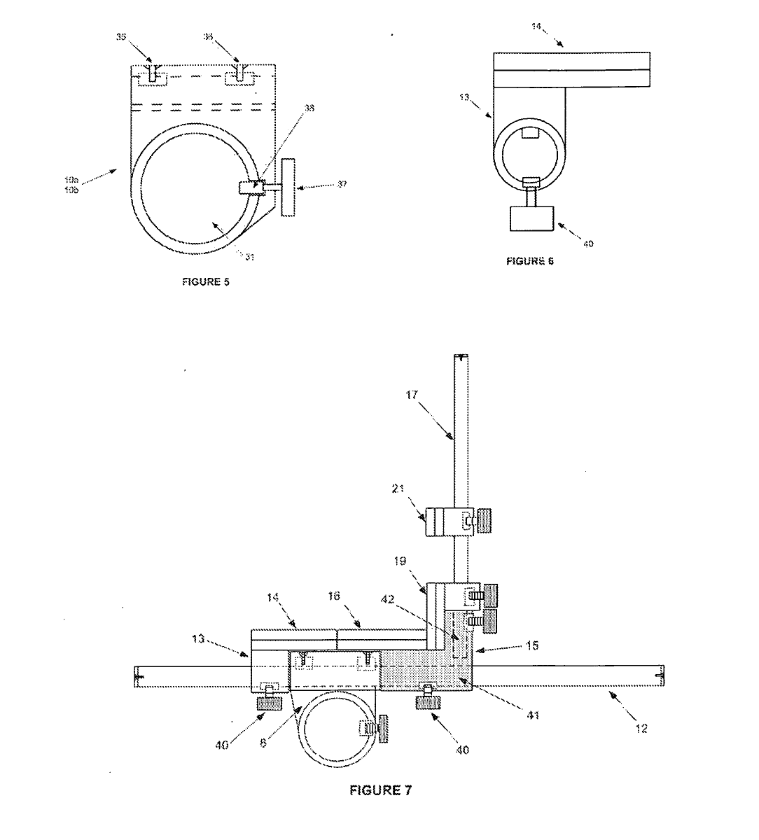

FIG. 7 shows one of the two rear rest assemblies comprising an L-shaped rod assembly 15 comprising a first horizontal bore 41 for receiving the supporting rod, and a second vertical bore 42 (shown in broken lines) for receiving a rear rod 17, and an overhanging rest 16. Two vertical rest units 19, 21 are provided, one above the other, on the rear rod 17 and are height adjustable to facilitate mounting of speakers of different heights.

The bottom vertical rest 19 is shown abutting flush behind the rear horizontal rest 16 when the rest 19 is adjusted and tightened in that position. The front and rear horizontal rests 14, 16, are also shown abutting flush and centrally over the top of the clamps and the central bearing assembly 8.

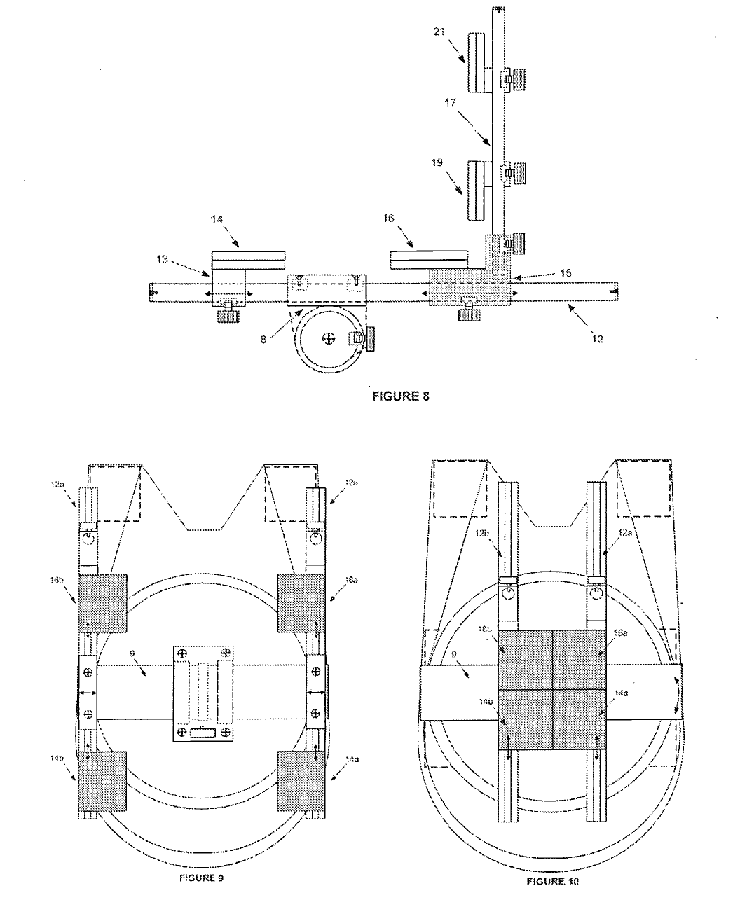

FIG. 8 shows a variation in adjustments to FIG. 7 where the bottom rear vertical rest unit 19 has been adjusted upwards on the back-rod 17 so that it no longer abuts flush behind the rear horizontal rest 16. Similarly, on the horizontal plane, the rear L-shaped assembly 15 has been moved back along the horizontal under-rod 12 away from the central bearing assembly 8, and the front rest unit 13,14 has been moved forward of the central bearing assembly.

FIGS. 9 and 10 show the range of adjustments on the horizontal plane more clearly from a top elevation. FIG. 9 shows each horizontal under-rod 12a, 12b adjusted out as far as possible on the tilt barrel 9 either side. Additionally, the rear rest units 16a,16b are adjusted as far back as possible on the under-rods, and the front rest units 14a, 14b are adjusted forward of centre, almost to their frontal limit on the under-rods.

Similarly, FIG. 10 shows the front and rear horizontal speaker rests adjusted as far towards the centre as of the tilt barrel 9 as possible, thus forming a contiguous platform for a speaker to be rested thereupon.

Thus, each of the two supporting rod carries a front and rear rest, and the two front rests and two rear rests together form a platform on which a speaker is mounted. Referring to FIGS. 7-10, the flexibility of the stand is illustrated in which movement of the rods along the tilt barrel, and movement of the rests along each supporting rod, together provide a multiplicity of different sizes of platform. The invention may be made in various sizes, such as small, medium and large, to encompass various average speaker families based on size, and within each invention size, the variability in adjustment thus enables the stand be adjusted to accurately support the base of almost all types of audio speakers. In addition, the supporting rods are adjustable in forwards and backwards orientation to allow the tilt angle of the platform be adjusted while maintaining the centre of gravity of the speaker over the base of the stand, thereby preventing the stand and speaker from toppling over.

FIGS. 11-14 refer to normal and specialist uses of the invention. FIG. 11 shows the optimum angles for desktop application, taking into allowance very tall users and minimum distances from the listener to the speaker of around 0.5 m (half a meter). Allowing for outliers and considering both extant research and international standards on VDU positioning, the maximum desktop angle is around 34 degrees. This is likely also to satisfy requirements for couch ear-eyeline height, bookshelf speaker placement and lounge floor placement, where the distance from the speaker to the listener is likely to be much longer than 0.5 m.

To satisfy requirements for some uses whereby the speaker needs to be inclined frontally downwards to a listener—such as when placed on a high meter bridge of a recording desk, the tilt action is able to be adjusted forward and downwards, past horizontal.

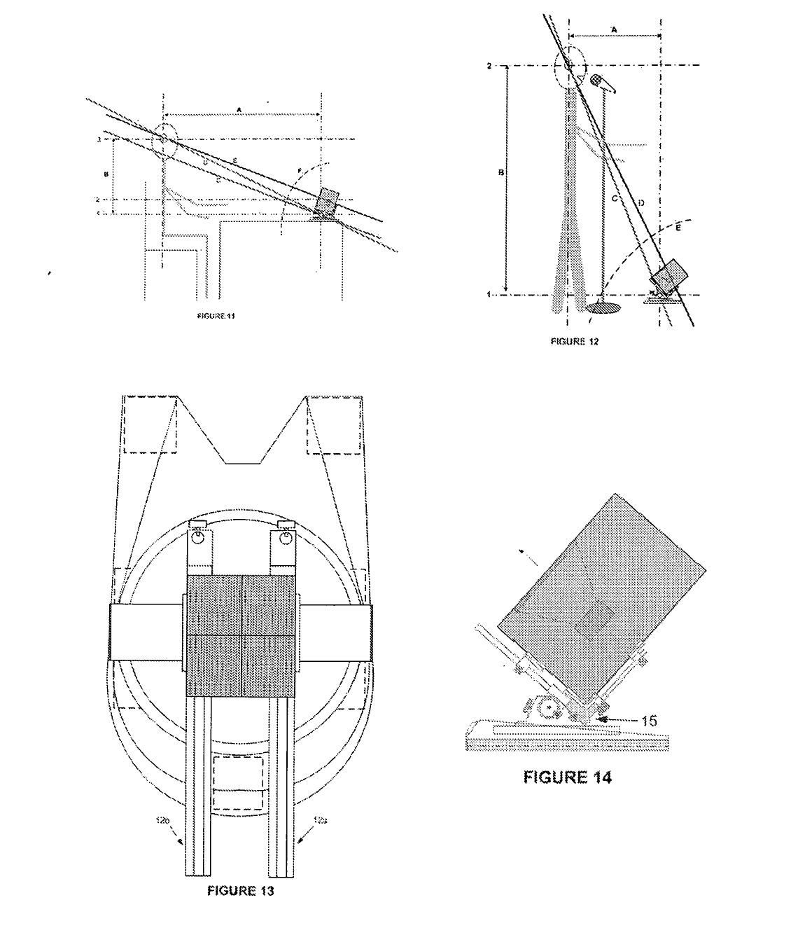

FIGS. 12-14 refer to a specialist use where the speaker needs to be placed on the stand on the floor, a minimum of 0.5 m from a standing performer, so that the invention may be used to place a speaker monitor thereupon for audio foldback. FIG. 12 shows the triangulation that arrives at an approximate angle of 76 degrees, being maximum backwards tilt of the invention, to achieve the required operation. As noted previously, and referring to FIG. 4 also, by unscrewing the two holding screws 35, 36, in each under-rod clamp 10, moving the under-rods as far forwards as possible in relation to the clamps, and then re-tightening the screws, this provides sufficient clearance at the rear of the invention, for the invention to be tilted to 76 degrees and thus achieve the required operation. FIG. 13 shows a top elevation of the under-rods 12a,12b adjusted as far forward as possible in relation to the central bearing assembly, and FIG. 14 shows a side elevation of a speaker tilted thus, in particular, the clearance necessary at the rear of the rear L-shaped component 15, to achieve the greater angle required.

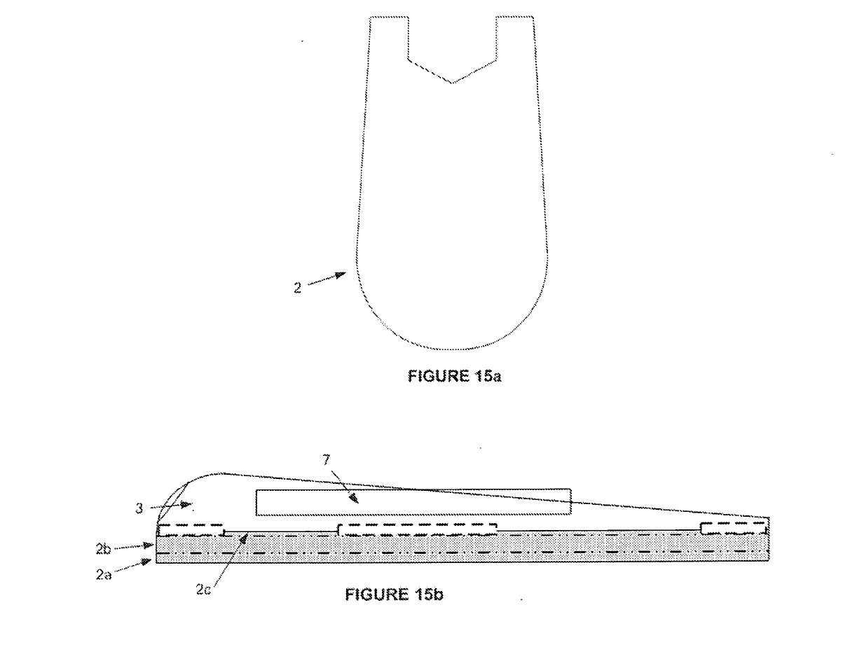

Referring to FIGS. 15a, 15b, an anti-vibration pad according to the invention and indicated generally by the reference numeral 2 is described, sitting atop the alloy base plate 3. The pad 2, ideally comprises a rubber housing having a rubber base layer 2a about 5 mm thick, and an upper gusset dimensioned to enclose a layer of sand 2b on top of the base layer 2a, with a top surrounding lip 2c which extends around the periphery of the pad. Although not shown, the pad is dimensioned to support the base 2 of the stand 1 with the lip 2c abutting the periphery of the base plate 3. In use, a speaker or speaker stand is seated on the stand that sits atop the pad, and the pad prevents or hinders the vibration of the stand being passed into the supporting surface under the pad. The invention will be offered in various embodiments and sizes, utilizing variable outer cladding and surface area graphic design for a particular market and utility purposes.

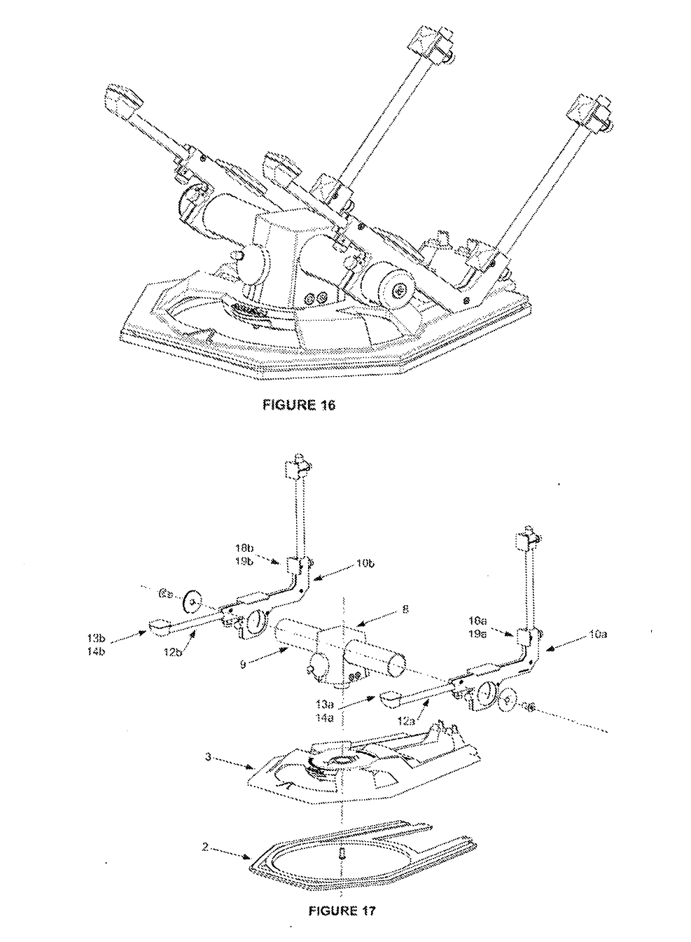

FIG. 16 shows a 3D illustration of a 2^{nd} embodiment of the invention.

FIG. 17 shows an exploded 3D view of the 2^{nd} embodiment. Using the same numbering references for like components as in the 1^{st} embodiment, and new number references for features not elaborated previously, we may identify firstly the relevant like components.

Referring to FIG. 17, the isolating base 2 performs the same function as for the 1^{st} Embodiment except that the design is varied. The Alloy base plate 3 sits atop the base 2. The tilt barrel 9 is seated within the central bearing assembly 8.

The front horizontal speaker rest units 13a, 13b, 14a, 14b, are differentiated in the 2^{nd} embodiment from the 1st embodiment, by being fixed to the front of the under-rods 12a, 12b, which are themselves able to move in and out of the cast clamp assemblies 10a, 10b.

In addition, the clamp assemblies 10a, 10b, are differentiated from the 1^{st} embodiment by being fixed to the bottom rear vertical speaker rest units 18a, 18b, 19a,19b for added strength.

In FIG. 18, the structural integrity for load bearing around a central pivot, and details of the rotation mechanism can be seen. The load bearing pivot 50 mates with the pivot bore guide 51, and similarly, the rotate mating chuck 52 mates with the rotate bushing 53.

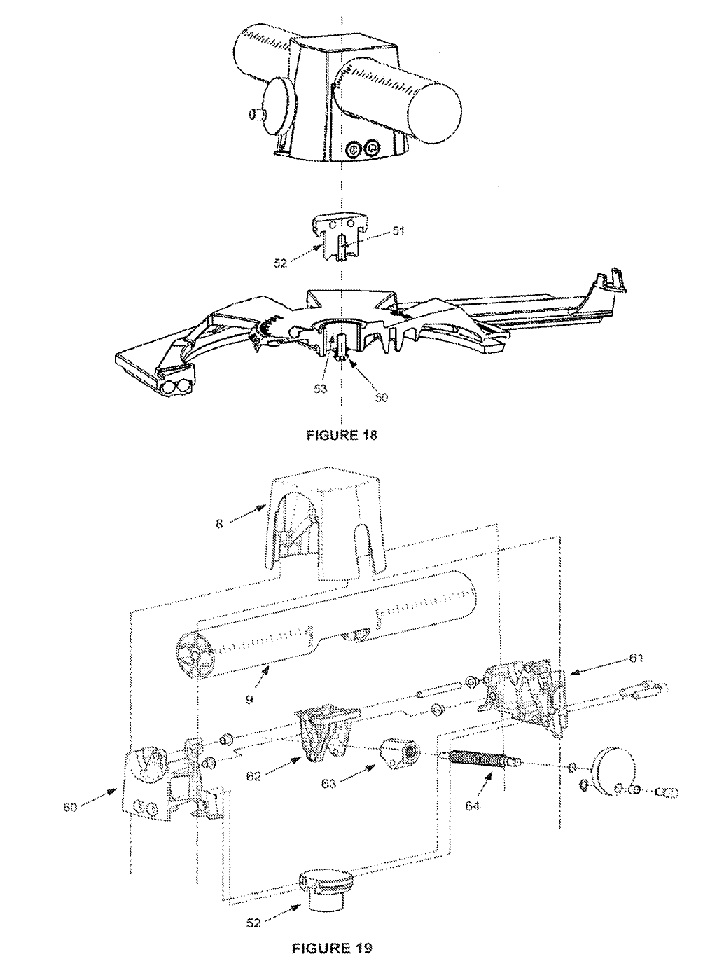

Referring to FIG. 19, the central bearing assembly 8 is assembled over the tilt barrel 9 and houses two casts 60, 61, assembled together, with a central fulcrum unit 62 that accepts the worm drive pivot nut 63 and the worm drive 64. The rotate mating chuck 52 (refer also FIG. 18) is also shown in its assembly relationship to the two casts 60, 61.

Referring to FIGS. 18 and 20, the horizontal rotation locking mechanism is shown in FIG. 20. The front horizontal locking wheel 70 may be wound clockwise to lock the invention from horizontal rotational movement, by means of lowering the central rotate mating chuck 52 onto the load bearing pivot 50, typically resting atop a floor surface guide 71, exterior and surrounding the load bearing pivot 52. The weight bearing down from the speaker and assemblies creates a lock on rotational movement of the central bearing assembly and its other assemblies and the speaker load atop. Typically, the floor surface guide may have detented gradations mating with indents in the underside of the mating chuck 52, to further assist the mating relationship and locking capability (not shown).

Similarly, by rotating the front horizontal locking wheel 70 anti-clockwise, the central rotate mating chuck 52 is lifted off the floor surface guide 71, thus permitting free horizontal rotational movement of the central bearing assembly, the other assemblies atop, and on all speaker load carried thereby.

The description of the horizontal locking mechanism in the 2^{nd} embodiment do not preclude other means to achieve the horizontal locking function of the invention.

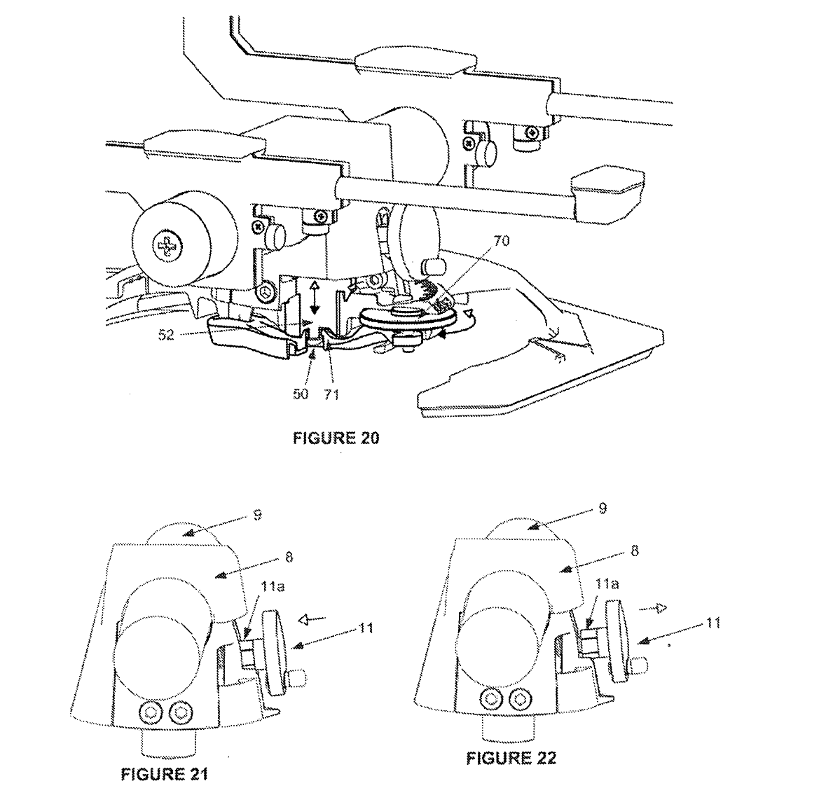

Referring to FIGS. 21 and 22, the vertical tilt barrel locking mechanism may be described. The tilt barrel 9 tilt mechanism is operated by means of a worm drive assembly (refer FIG. 19 references 62,63,64.) In FIG. 21, the front tilt wheel adjustor 11 may be operated clockwise, to turn the tilt barrel anti-clockwise (in perpendicular relationship to the front tilt wheel adjustor), achieving a backwards tilt movement for the speaker rest assemblies attached to the tilt barrel as described previously.

The front tilt wheel 11 is able to be engaged or disengaged from the tilt mechanism by means of pulling the wheel itself out or pushing it in, in relation to the central bearing assembly 8. Referring to FIG. 21, pushing the tilt wheel adjustor 11 inwards engages the tilt wheel adjustor hexagonal bush 11a with a mating perimeter guide around its exterior (not shown) and locks the tilt mechanism in place. Referring to FIG. 22, pulling the tilt wheel adjustor 11 outwards disengages the tilt wheel adjustor hexagonal bush 11a from its perimeter guide, and unlocks the tilt mechanism, enabling the tilt function to operate.

The description of the tilt locking mechanism in the 2^{nd} embodiment does not preclude other means to achieve the tilt locking function of the invention.

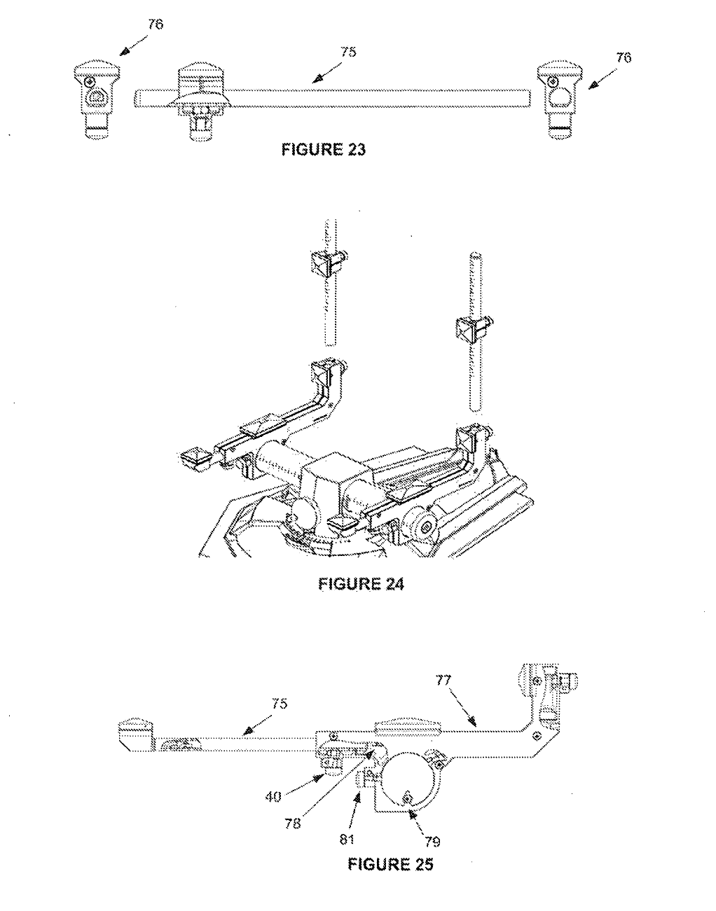

Referring to FIG. 23, and in particular to speaker rests and rods, the 2^{nd} embodiment utilises half-round horizontal and vertical speaker rods (a generic example of the half-round horizontal rod is referenced as 75), and half-round bores in the rest clamps (generic examples are referenced as 76). Whereas the 1^{st} embodiment utilises grooves and keys (refer FIG. 4, references 33, 34), to maintain perpendicular relationships between the speaker rods and the clamps, and to prevent unwanted rotation of one against the other, the 2^{nd} embodiment utilises half-round horizontal and vertical rods, and half-round bores in the speaker rest clamps, to maintain the necessary perpendicular relationships between the rods and the rests.

Referring to FIG. 24, ideally the vertical back-rods are removable to assist in flat-packing the invention for space efficiency and protection in packaging and delivery.

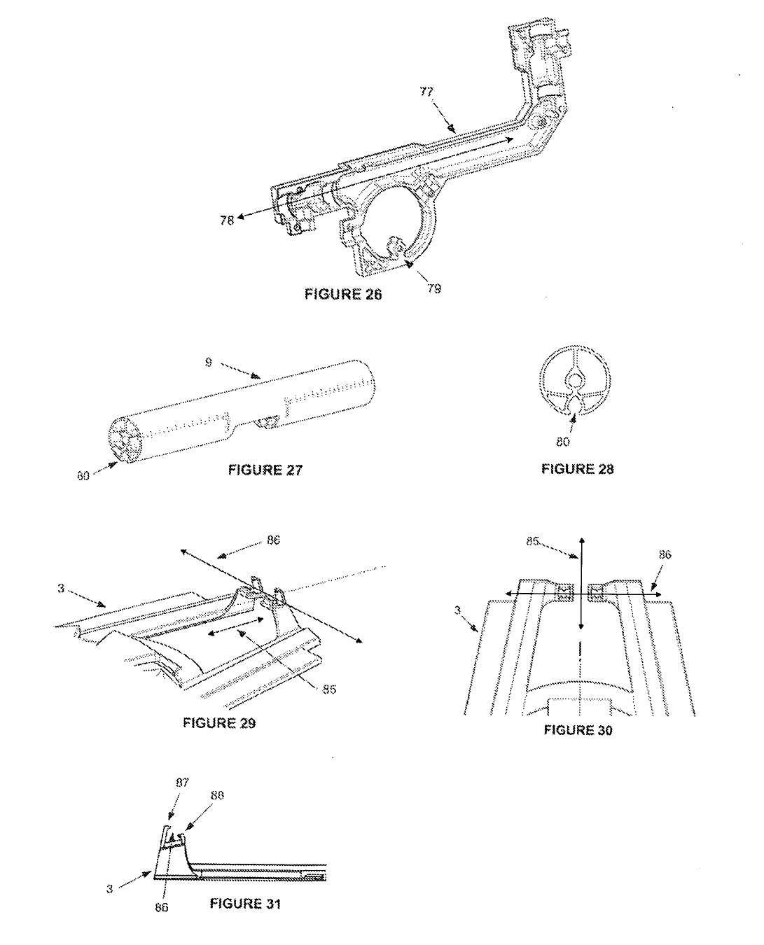

Referring to FIGS. 25-28, and in particular to FIGS. 25, 26, the horizontal support rod 75 is adjustable by means of a wheel nut 40 (refer also FIG. 6, reference 40) and may be moved inwards and outwards in relation to the clamp 77 and tightened in place. The support rod 75 moves within a bore 78 internal to the clamp 77.

Whereas in the 1^{st} embodiment, the perpendicular relationship between the tilt barrel 9 and the horizontal speaker rods is maintained by grooves and keys (refer FIG. 3, reference 30, and FIG. 5, reference 38), the 2^{nd} embodiment utilises a spigot 79 (FIGS. 25, 26) mating with a guide channel 80 (FIGS. 27, 28) in the tilt barrel 9.

Each clamp 77 may be adjusted across the tilt barrel 9 and tightened in place by a wheel nut 81 (FIG. 25). Thus, the tilt barrel may be tilted with the speaker rods and rest assemblies and a heavy speaker atop, in a robust manner.

Referring to cable management, active speakers will have both power and audio cables protruding from the rear. Electromagnetic interference or EMF may occur when both power and audio cables are lain together in a parallel relationship, with the potential to degrade and interfere with the audio emanating from the speaker. This may occur where electronic circuits are affected by electromagnetic induction or radiation from an external source such as power, or interference patterns from the different frequencies at which the power and the audio signals are conducted through the cables. The method employed by the invention to minimise the potential for EMF, is to provide to the rear of the invention, a 90 degree orthogonal cable management structure, so that the audio and power cables can cross at 90 degrees on ingress/egress the speaker.

Referring to FIGS. 29-31, the 2nd embodiment includes a cable management structure at the rear of the base plate 3. The speaker cable may be laid on a lower plane 85 permitting the cable to lead straight back and centre behind the base plate 3, whereas the power cable may be laid on higher plane 86 between guide lugs 87, 88, at 90 degrees to the lower plane 85. Referring to the lower plane, 85, no fastenings are required for the cable, and it would lay on top of the isolating base that sits underneath the allow base plate 3. The isolating base is not shown in FIGS. 29-31, please refer to FIGS. 1, 2 and reference 2.

Referring to FIG. 31, the guide lugs 87,88 can be shown clearly in side elevation on the higher plane 86.

The description of the cable management in the 2^{nd} embodiment does not preclude other means to achieve the cable management function of the invention.

Referring to the isolating base, the 1^{st} embodiment prefers a solid flat base made from sound and mechanical vibration isolating materials, typically SBR Shore A synthetic rubber, together with an upper gusset filled with sand, atop which the alloy base is seated as previously described. (Refer FIG. 15a,15b).

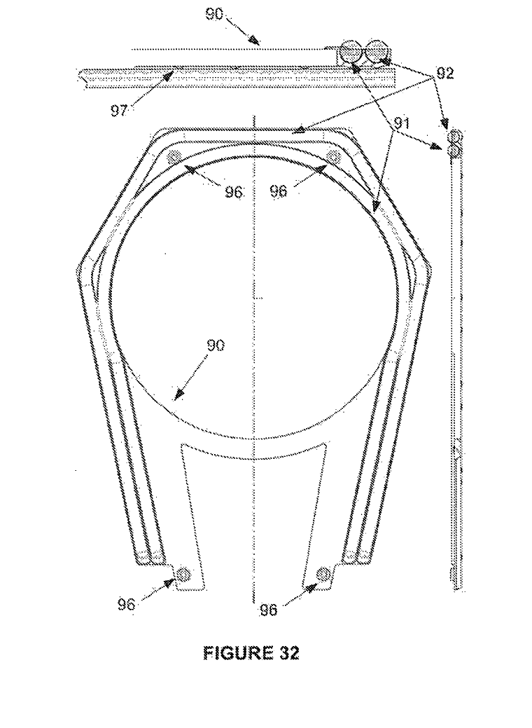

Referring to FIGS. 32-34, the 2^{nd} embodiment has an isolating base 90, atop which the alloy base 3 is seated (refer also FIG. 15b, reference 3). The isolating base 90, has two sand-filled pipes 91, 92 that are laid in grooves 93, 94 on the top surface of the isolating base 90, and are typically glued in place.

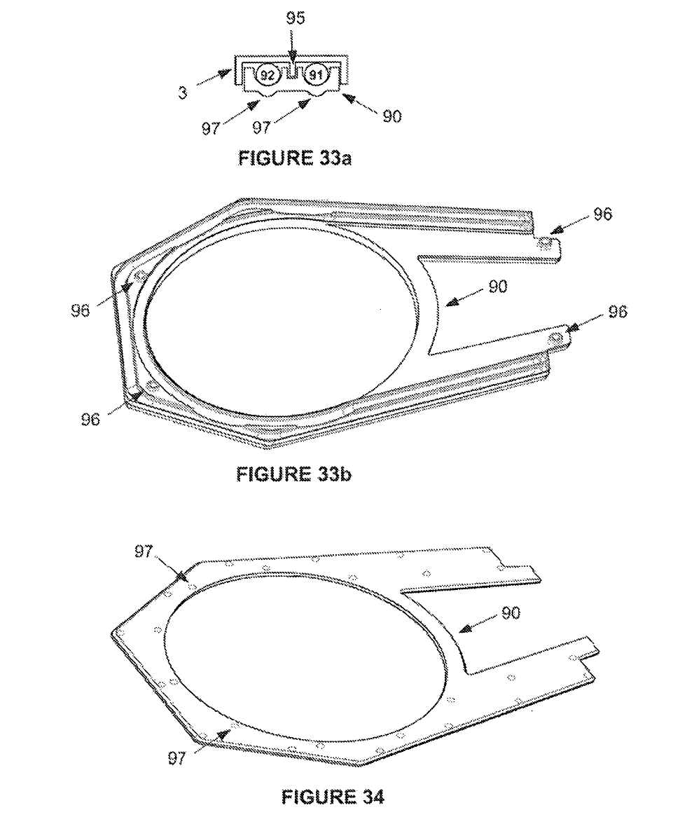

On the under side of the alloy base plate 3, are guiding lugs 95 (refer FIG. 33a), that seat in mating holes 96 (refer FIGS. 32, 33b) on the top surface of the isolating base 90. The guiding lugs ensure the allow base plate and all load bearing assemblies and the speaker atop, are correctly located on top of the isolating base, without the need for fixing the allow base plate to the isolating base.

The under-side of the isolating base 90, has a number of dimples 97, that permit the isolating base to sit up, typically 2-3 mm, above any mounting surface upon which the invention may be placed, to provide further isolation from mechanical vibration.

Referring to FIG. 33a, in cross-section through the alloy base 3 and the isolating base 90, the placement of the alloy base 3 atop the isolating base 90, can be seen clearly. The alloy base 3, rests atop the sand-filled pipes, 91, 92, and the outer perimeters of the alloy base 3, rest snugly over the sides of the isolating base 90, without a permanent fastening relationship between the alloy base and the isolating base. The underside of the alloy base 3, does not meet the top side of the isolating base, except by means of the sand-filled pipes. This allows the alloy base to sustain mechanical vibration through the emission of sound from the speaker, and to refer the vibration via the sand-filled pipes 91, 92 atop the isolating base, acting as one of the many dampening measures of the invention.

The descriptions of the isolating base do not preclude other materials and constructions for the base to achieve the isolating function of the invention. The isolating base may be entirely made from SBR synthetic rubber or similar, and with or without under-side dimples, sand-filled pipes, and the like.

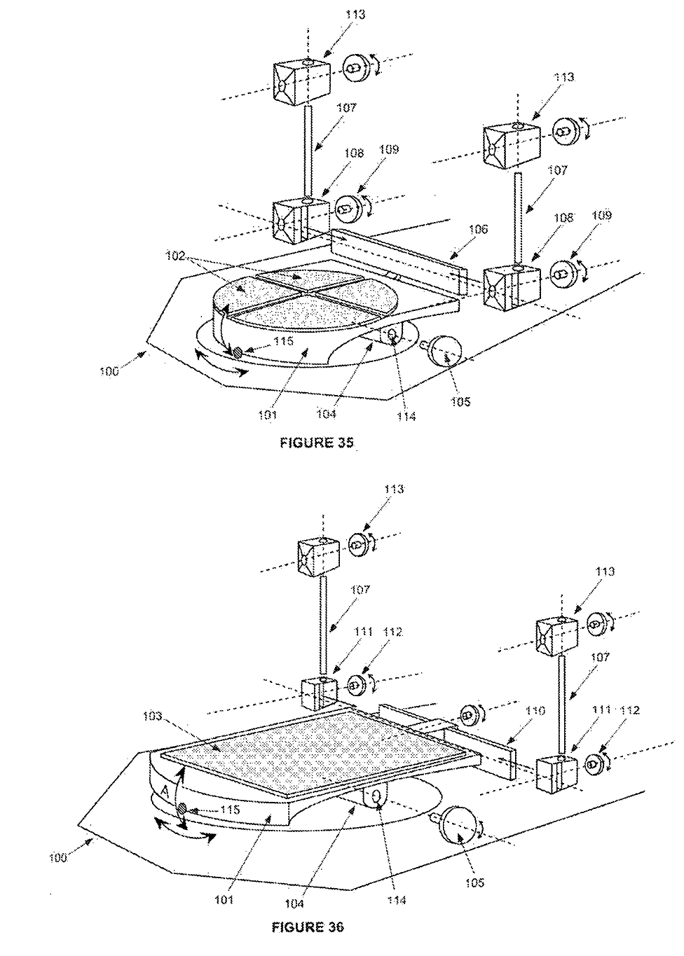

The 3^{rd} embodiment is shown in FIG. 35 and the 4^{th} embodiment in FIG. 36, representing less-complex, mass-manufacture designs of the invention.

Referring to FIGS. 35 and 36, the alloy base is of the same construction and description as the 2^{nd} embodiment (refer FIG. 17, reference 3), but shown only as a 4-line representation with reference number 100.

The 3^{rd} and 4^{th} embodiments utilise the rotate mechanism described for the 2^{nd} embodiment, but replace the tilt barrel and horizontal supporting rods with a simplified single rest unit 101, that has either multiple speaker rests 102 atop or a single rest surface 103, and with a simplified tilting mechanism 104 and tightening nut 105, atop the allow base 100 and its rotate mechanism (not shown).

The speaker rests 102, 103, may be flat with wide surface area (s) contacting the under-side of the speaker, or they may have dimples (not shown) to provide further separation and isolation between the speaker and the rest (s).

Referring to FIG. 35, in the 3^{rd} embodiment, the rear fixed guide track 106, permits the rear speaker rods 107, to be mounted on the bottom rear speaker rest units 108, and slipped across the fixed guide 106, for inwards and outwards adjustment laterally to the base plate 100, according to the width of the speaker. The bottom rear speaker rest units 108, may then be tightened in place with the adjusting wheel nuts 109.

Referring to FIG. 36, in the 4^{th} embodiment, the rear guide track 110 is removable, and may be replaced with an extended guide track for the purposes of permitting wider adjustment laterally of the vertical rear speaker rods 107 along the extended guide track (not shown), for use, by way of example, where speakers are laid on their long sides—a relatively common practice for some speakers.

The bottom rear vertical rod assemblies 111, do not also serve to carry speaker rests themselves, but only to accept the vertical rods and upper speaker rests and to provide lateral adjustability in the width of the vertical rods and rests across the rear guide track 110, by a tightening wheel nut 112. To be clear, the 4^{th} embodiment has two upper vertical speaker rest units 113 only, whereas the 3^{rd} embodiment (refer FIG. 35), has two lower vertical speaker rest units 108, and two upper vertical speaker rest units 113.

Referring to FIGS. 35 and 36, in both the 3^{rd} and 4^{th} embodiments, the tilt mechanism 104, fixes the tilt adjustor wheel nut 105 to the bore 114, enabling the single rest unit 101 to be loosened for tilt and then tightened in place at the desired tilt angle.

The simplified tilt mechanism and speaker mounting surface (s) as shown in the 3^{rd} and 4^{th} embodiments, may include an enclosed fluid or other friction-enhancing means to ensure the speaker does not topple backwards when the tilt adjustor nut 105 is un-tightened. Similarly, rubber stops 115, may be deployed front and rear of the single rest unit, to ensure safety limits when un-tightening the adjustor nut 105.

Referring now to the invention in general, including, but not limited to, all the embodiments heretofor illustrated by the figures, an adjustable support for an audio speaker according to the invention has a number of advantages.

In the 1^{st} embodiment, the front and rear speaker rests mounted on the two supporting rods together form a platform on which the speaker is supported.

The ability of the supporting rods to move sideways (i.e. together and apart), added to the adjustability of the front or rear, or front and rear, rests along each supporting rod, allows a large degree of flexibility in the size and position of the speaker platform, enabling the support to be used with different sizes and shapes of speakers. The tiltable support (i.e. tilt barrel) enables the angle of the platform to be easily adjusted. However, tilting of the platform generally results in the centre of gravity of the audio speaker to shift which, in the case of large and/or heavy speakers, can destabilize the speaker on the platform. This problem is overcome in the device of the invention by the provision of supporting rods that are moveable forwards and backwards relative to the tiltable support. Thus, the rods can move the audio speaker platform forwardly and rearwardly relative to the platform by the four speaker rests. This serves to readjust the centre of gravity of the speaker closer to a stable position over the central bearing assembly.

Preferably, the upright bearing is rotatable relative to the base. This enables the audio speaker to be rotated, typically about a vertical axis. Suitably, the bearing comprises a circular base plate adapted for seating in a circular socket formed in the base. Various means may be provided for enabling smooth and easy rotation of the base of the bearing in the socket of the base. The degree of rotation of the bearing with respect to the base is ideally limited to an arc of less than 120 degrees, suitably less that 105 degrees, and preferably from 80 degrees to 100 degrees, and ideally about 90 degrees. Typically, when in a centered position, the tilt barrel is substantially perpendicular to a longtitudinal axis of the base, and upright bearing is capable of rotation of from 40 degrees to 55 degrees, ideally up to about 45 degrees each side of this centered position.

Preferably, the upright bearing has a bore adapted for engagement of the tilt barrel. The bore is dimensioned to enable a tight but sliding fit of the tilt barrel. Typically, the upright bearing is provided in two parts which are adapted to be separated and reassembled to embrace the tilt barrel. Suitably, adjustable locking means are provided for locking the tilt barrel in a desired rotational disposition.

The tilt barrel ideally comprises a cylindrical body adapted for rotatable mounting on the upright bearing. The tilt barrel includes a series of formations, for example threads or teeth, circumferentially arranged on the barrel intermediate its ends. The purpose of the formations is to assist in rotation (tilting) of the barrel. Ideally, a tilt or rotation mechanism is provided and includes a worm screw disposed on the upright bearing for engagement of the formations on the tilt barrel, wherein rotation of the worm screw actuates tilting of the tilt barrel. An actuation means is provided for rotation of the worm screw. Typically, the actuation means is a nut that extends proud of the upright bearing housing.

Ideally, each supporting rod is mounted on the tilt barrel by means of a connecting clamp. Suitably the clamp comprises two bores formed at right angles, typically a first bore dimensioned for receiving the tilt barrel and a second bore dimensioned for receiving a supporting rod.

Adjustable locking means are provided to allow locking of the clamp in a number of different positions along the tilt barrel.

Guide means are provided to allow movement of the clamp along the tilt barrel (i.e. along an axis of the tilt barrel) while preventing movement of the clamp around the axis of the tilt barrel. This effectively keeps the supporting rods generally perpendicular to the tilt barrel. The guide means typically comprise a groove formed on the outside of tilt barrel parallel to the axis of the tilt barrel. The clamp includes a projection which, in use, engages the groove in a tight but sliding fit, and prevents rotations movement between the clamp and tilt barrel.

The adjustable locking means comprises a nut mounted on the clamp and adapted for engagement of the tilt barrel.

The or each supporting rod is adjustably mounted relative to the tilt barrel, preferably by means of the connecting clamp. The second bore forming part of the clamp is dimensioned for tight but sliding engagement of a supporting rod.

Locking means are provided for locking the clamp in a number of different positions along the rod. Additionally, guide means are provided to prevent relative rotation between the clamp and rod.

The guide means typically comprise a groove formed along an outside of the rod, and a projection disposed on the clamp for engagement of the groove, thus guiding relative movement between the clamp and rod but preventing rotational movement.

Each supporting rod comprises a front speaker rest and a rear speaker rest, and each is suitable movable along the rod. Each of the front and rear rests ideally comprises a clamp portion, and a platform portion. The clamp comprises a bore dimensioned for engagement with a supporting rod, and ideally a projection for sliding engagement with a groove formed in the rod. This ensures that while the rest clamp can slide along the rod, rotational movement of the clamp on the rod is prevented.

The platform portion of the rest is typically located above the clamp part, and comprises an essentially flat support that projects beyond the clamp. The platform part of the front rest projects backwards towards the rear rest, and the platform part of the rear rests project forwards towards the front rest. In this manner, the four platform parts of the four rests can be brought together in abutment over the main connection clamps for each connecting rod.

One or both of the supporting rods includes a rear rod disposed towards the rear of the supporting rod, and extending typically at a right angle to the supporting rod. The purpose of the rear rod is to support the rear of the audio speaker, either on its own, or by means of vertical rests which are movable mounted on the rear rod. In one embodiment, the clamp forming part of the rear rest includes a bore for engagement of the rear rod.

Thus, the clamp of the rear rest may be generally L-shaped. Suitably, the rear rod comprises one or more rear (or vertical) rests which are moveable in a vertical manner along the rear rod, although the or each rear rest may be fixed. In one embodiment of the invention, the L-shaped clamp includes one fixed rear rest.

Suitably, the platform parts of the vertical rests are smaller that those of the rear and front (horizontal) rests.

The rests of the stand of the invention support the audio speaker. Each rod provides at least a front rest and a rear rest (for supporting the front and rear of the base of the speaker). However, the front and rear rests may be provided by means of a unitary rest, which can be moved along the rod and in other embodiments, by a tiltable base plate, without rods entirely as will be explained further below.

In another embodiment, one of the front or rear rests may not be adjustable with respect to the rod; for example, the rear rests may be fixed in position, and the front rest adjustably mounted on the rod, or vice versa.

In one or other embodiments, the tilt barrel, supporting rods and rests may be replaced with simplified single rest units that have single or multiple speaker rests atop, and with a simplified tilt mechanism, whilst the rotate mechanism, alloy base plate and rubber isolating base remain similar in construction and purpose.

The invention also relates to an anti-vibration pad, for example a pad suitable for seating an audio speaker, a speaker stand, a microphone stand, a musical instrument, a microphone stand, drums, pedals for drums, amplifiers, sensitive electronic equipment, and the like, the pad comprising two layers comprising a base layer formed of an elastomeric material, ideally rubber, supporting an upper sand layer, wherein the sand layer is enclosed. The lower layer contacts the floor or ground, and the upper layer supports the speaker, or a speaker stand. Typically, the sand layer is contained within a gusset formed in the pad, but it may also encompass other forms, such as sand-filled piping, strips or pockets.

Suitably, an upper surface of the pad (which in use abuts the alloy base plate of the speaker stand, and will probably be part of the gusset containing the sand) comprises a lip extending around all or part of a periphery of the upper surface. The purpose of the lip is to help retain the speaker or speaker stand in position on the pad. In one embodiment, the pad is dimensioned for mating engagement with a speaker base or speaker. Thus, various sizes and shapes of pads are envisaged, and typically the lip on the pad is dimensioned to snugly receive an alloy base plate or speaker of given proportions.

In a preferred embodiment, the pad is between 5 mm and 50 mm thick, suitably between 5 and 20 mm thick, and ideally between 8 and 15 mm thick. Suitably, the base layer is from 2 to 20 mm thick, typically from 3 to 15 mm thick, and ideally from 3 to 10 mm thick. Suitably, the sand layer is from 2 to 20 mm thick, typically from 3 to 15 mm thick, and ideally from 3 to 10 mm thick.

In addition, the anti-vibration pad, in various embodiments, is intended for use on its own as an anti-vibration device to locate microphones on small stands on top thereof, in studio and stage situations where it is necessary to ‘decouple’ vibration from being picked up by the microphone. Some examples are, excessive vibration through the floor arising from the foot pedal operation of a kick-drum, and sensitive wind instrument microphones where there is excessive floor mechanical vibration from other sources, such as shuffling feet, etc.

In one or other embodiments, the isolating base may be of a different design, and include sand-filled pipes attached atop a solid SBR rubber (or similar compound) base. The base may also have dimples on the underside, to provide further isolation against mechanical vibration.

The support stand of the invention is particularly suited for supporting audio speakers, including large and robust stage and performance speakers such as PA speakers, stage monitors and the like However, it is also suitable for use with smaller speakers, such as studio speakers and high-end domestic speakers. The stand may also be used to support other devices such as televisions and visual monitors.

The advantage of a stand of the invention is the flexibility of design which allows the stand be used to support audio speakers of different shapes, sizes and weights. This is facilitated by the provision of a support platform for the speaker in several embodiments formed by two adjustable supporting rods, wherein the rods are movable together and apart (defining the width of the support platform), two speaker rests on each rod which are adjustable along the length of the rod (defining the length of the support platform, and particularly the fact that rods are themselves adjustable with respect to their support (which enables the support platform itself to be adjusted forwards and backwards with respect to upright bearing). In most embodiments of the invention, the rods are supported on a tilt barrel, however it is envisaged that the rods may be adjustably supported on other types of supports, both supports that are capable of tilting movement (such as a tilt barrel), and those that do not tilt (for example a simple supporting rest fixed to the upright bearing). In addition, other means of speaker support form part of the invention, such as a tiltable base plate without rods, for less complex and economically less expensive embodiments.

The invention does not preclude enhanced embodiments with electro-mechanical tilt and rotate functions and with wireless or infra-red remote control of the electro-mechanical functions, in particular, the ability to program memory positions in a memory bank held in a hand-held remote device for left and right speaker positions, according to varying heights and positions of users. This is particularly useful in a recording studio, where different recording engineers operate the same mixing consoles and equipment on different shifts or at different times, where adjustment to the optimum speaker location with respect to the hearing location, is desired.

1. An adjustable stand suitable for supporting an audio speaker and comprising:

2. a base having an upright bearing;

3. a tilt barrel mounted on the upright bearing for adjustable rotation about its own axis;

4. two supporting rods, each supporting rod being mounted on the tilt barrel generally perpendicular to the tilt barrel axis and adapted for movement sideways along the tilt barrel and forwards and backwards relative to the tilt barrel; and

5. A front and rear rest disposed on each supporting rod, at least one of which is mounted for movement along the rod,

6. An adjustable stand as claimed in claim 1 in which the upright bearing is rotatably mounted to the base.

7. An adjustable stand as claimed in claim 1 or 2 in which each supporting rod is mounted on the tilt barrel by means of a connecting clamp comprising a first bore dimensioned for receiving the tilt barrel and a second bore dimensioned for receiving a supporting rod, wherein the first bore is disposed at a right angle to the second bore.

8. An adjustable stand as claimed in claim 4 in which the connecting clamp comprises locking means for adjustably locking the clamp to a plurality of position along the tilt barrel.

9. An adjustable stand as claimed in claim 4 in which the locking means comprises an adjustable projection adapted to engage a groove formed along the tilt barrel.

10. An adjustable stand as claimed in claim 3, 4 or 5 in which the connecting clamp comprises locking means for adjustably locking the clamp to a plurality of position along a connecting rod.

11. An adjustable stand as claimed in claim 6 in which the locking means comprises an adjustable projection adapted to engage a groove formed along the supporting rod.

12. An adjustable stand as claimed in any of claims 3 to 7 in which the second bore comprises an elongated groove dimensioned for engagement with a corresponding projection formed along the supporting rod.

13. An adjustable stand as claimed in any of claims 4 to 8 in which locking means comprises an adjustable nut having a head dimensioned for engagement of the groove.

14. An adjustable stand as claimed in any preceding claim in which each of the front and rear rests comprises a clamp portion adapted for adjustable engagement with a supporting rod, and a platform portion adapted for seating part of a base of a speaker.

15. An adjustable stand as claimed in claim 11 in which the clamp comprises a bore dimensioned for engagement with a supporting rod, and a projection for sliding engagement with a groove formed in the rod.

16. An adjustable stand as claimed in any preceding claim in which one or both of the supporting rods include a rear rod disposed towards the rear of the supporting rod, and extending at a right angles to the supporting rod, the rear rod comprising at least one height adjustable vertical rest.

17. An adjustable stand as claimed in any preceding claim in which the width of the base is greater than or equal to the width of the tilt barrel.

18. An adjustable stand as claimed in any preceding claim in which the length of the base is greater than or equal to the length of the or each supporting rod.

19. An adjustable stand as claimed in any preceding claim in which the rear rests are fixed in position on the supporting rod and the front rests are movable along the rod.

20. An adjustable stand as claimed in any preceding claim in which the rear and front rests are movable along the rod.

21. An adjustable stand that has a simplified tilt mechanism and speaker platform comprising a single plate with single or multiple elastomeric speaker rests atop, and with the speaker platform able to tilt on a central axis, atop a rotate mechanism attached to a base plate.

22. An adjustable stand as claimed in any preceding claim that has a tilt locking and locking mechanism, and rotate locking and unlocking mechanism.

23. An adjustable stand as claimed in any preceding claim that has a cable management system to separate power and audio cables orthogonally and so provide a means to dampen or remove altogether the potential for EMF interference.

24. An adjustable stand as claimed in any preceding claim that has electro-mechanical means to achieve the tilt and rotate mechanisms and with wireless or infra-red hand-held remote capability to effect the operation of the tilt and rotate mechanisms and to store memory locations of each speaker placed on the invention, for different users.

25. An anti-vibration pad comprising a base layer of elastomeric material and an upper of layer of sand disposed on top of the base layer of rubber and enclosed within a casing.

26. An anti-vibration pad as claimed in as claimed in any preceding claim in which the upper surface of the pad includes a raised lip extending around a periphery of the pad.

27. An anti-vibration pad as claimed in any preceding claim in which the pad is dimensioned for seating a base of a speaker or a speaker stand.

28. An anti-vibration pad as claimed in any preceding claim that has sand-filled pipes atop a solid elastomeric base, that has, in itself, dimples on the underneath side, to permit separation between the mounting surface and the pad itself.
